(19) United States
(12) Patent Application Publication
(10) Pub. No.: US 2001/0033904 A1
(43) Pub. Date: Oct. 25, 2001

(54) Planographic printing plate packaging material and planographic printing plate packaging structure

(76) Inventors: Takayuki Usui, Shizuoka-ken (JP); Tokiichi Masuda, Shizuoka-ken (JP)

Correspondence Address: SUGHRUE, MION, ZINN, MACPEAK & SEAS, PLLC, Suite 800, 2100 Pennsylvania Avenue, N.W., Washington, DC, 20037-3213, US

(21) Appl. No.: 09/788,351

(22) Filed: Feb. 21, 2001

(30) Foreign Application Priority Data
Mar. 3, 2000 (JP) 2000-58533
Mar. 14, 2000 (JP) 2000-70263

(51) Int. Cl. B32B 1/06

(52) U.S. Cl. 428/34.1

(57) ABSTRACT

A surface of an interleaf sheet 14 for protecting a coating film of a planographic printing plate 10, which does not contact the coating film of the planographic printing plate 10, has a Bekk smoothness between 3 seconds to 55 seconds. A contacting portion of the interleaf sheet 14, which contacts the coating film, has a Bekk smoothness between 3 seconds to 900 seconds.

### BACKGROUND OF THE INVENTION

1. Field of the Invention

The present invention relates to a planographic printing plate packaging material and a planographic printing plate packaging structure.

More particularly the present invention relates to a planographic printing plate packaging material which contacts at least partially to an imaging surface of a planographic printing plate to protect the imaging surface while wrapping the planographic printing plate; and to a planographic printing plate packaging structure using this planographic printing plate packaging material.

In addition, more particularly, the present invention relates to a planographic printing plate packaging material which contacts a coating film of a planographic printing plate to protect the coating film; and to a planographic printing plate protection structure using this packaging material.

2. Description of the Related Art

In plate making methods of recent years (including electrophotographic plate making methods), planographic printing plates such as photosensitive printing plates or heat sensitive printing plates are widely used in order to facilitate automation of a plate making process. A planographic printing plate is produced by performing surface treatments such as graining, anodic oxidation, silicate treatment, or other chemical conversion treatment solely or in combination as necessary on a substrate which is typically a sheet-shaped or coil-shaped aluminum plate, and then coating a photosensitive layer or a heat sensitive layer (these are referred to as “coating film”), drying, followed by cutting to a desired size. This planographic printing plate is subjected to a plate making process including exposure, development, gum coating and the like, then set in a printing machine, applied with ink, thus, texts, images and the like are printed on pieces of paper.

In order to protect the coating film of the planographic printing plate, a piece of paper, called “interleaf sheet”, may be placed in contact with the coating film (imaging surface). Especially, in order to handle planographic printing plates efficiently, a plurality of planographic printing plates may be stacked in a thickness direction to form a stack of the planographic printing plate type and the stack may be handled. In this case, it is preferable to protect the imaging surfaces (coating films) by, for example, alternately stacking the above described interleaf sheets and the planographic printing plates so that the interleaf sheets contact the imaging surfaces, or placing pieces of cardboard for protection, called “protection cardboard” at end surfaces in a stacking direction or at every predetermined number of the planographic printing plates.

When planographic printing plates having such interleaf sheets or pieces of protection cardboard placed in contact with imaging surfaces thereof are used in an automatic plate-making machine or the like, the interleaf sheets or the pieces of protection cardboard need to be separated from the planographic printing plates. Therefore, efficiency of a plate-making operation can be improved by using an automatic plate-making machine having an automatic plate feeding function which automatically separates interleaf sheets and feeds planographic printing plates, a so-called plate-setter, or the like.

However, when a plurality of planographic printing plates and interleaf sheets are alternately stacked in a thickness direction to form a stack, a surface (non-contacting surface) opposite to a surface of the interleaf sheet contacting the imaging surface contacts a non-imaging surface of a neighboring planographic printing plate. When the non-contacting surface is strongly adhering to the non-imaging surface, the interleaf sheet is fed together with the planographic printing plate without being separated therefrom at a time of plate feeding, and inconveniences such as stop of automatic feeding operation or the like may be caused. For example, when an planographic printing plate is lifted with an imaging surface thereof being sucked, an interleaf sheet which has protected an imaging surface of a neighboring planographic printing plate is lifted together adhering to a non-imaging surface of the lifted planographic printing plate, and the planographic printing plate and the interleaf sheet are fed together. Further, when a planographic printing plate is lifted with a non-imaging surface thereof being sucked, several interleaf sheets and planographic printing plates adhering to the underside of the lifted planographic printing plate are fed together, and therefore the automatic plate feeding operation may stop.

For this, an interleaf sheet made of synthetic pulp blended paper which has been subjected to a heat-press treatment is described in Japanese Patent Application Laid-Open (JP-A) No. 2-25845. By forming an interleaf sheet in this manner, separability of the interleaf sheet from a planographic printing plate is improved and damage to a coating film is prevented.

However, since synthetic pulp itself is expensive, material costs of the interleaf sheets become high. Further, since synthetic pulp blend paper needs to be produced separately from ordinary paper, production costs of the interleaf sheets also become high.

Next, when a plurality of planographic printing plates are stacked for transportation or the like, pieces of paper, called “interleaf sheets”, may be placed in contact with coating films coated on the substrate in order to protect the coating films. Further, a piece or pieces of cardboard for protection, called “protection cardboard” may be placed at at least one of surfaces in stacked direction of the stacked planographic printing plates. Particularly, in order to handle planographic printing plates efficiently, a plurality of planographic printing plates may be stacked in a thickness direction to form a stack of the planographic printing plate type, and the stack may be handled in a packaged state. In this case, it is preferable to contact the interleaf sheets or the pieces of protection cardboard with the coating films.

For example, an interleaf sheet made of synthetic pulp blended paper which has been subjected to a heat-press treatment is described in JP-A No. 2-25845. By forming an interleaf sheet in this manner, peeling of a coating film caused by being rubbed by planographic printing plates (so-called “film peeling”) does not occur.

However, since synthetic pulp itself is expensive, material costs of the interleaf sheets become high. Further, since synthetic pulp blend paper needs to be produced separately from ordinary paper, production costs of the interleaf sheets also become high.

On the other hand, a packaging structure for photosensitive printing plates (planographic printing plates) in which at least one of interleaf sheets and pieces of protection cardboard having moisture content of less than or equal to 8% are used is shown in JP-A No. 3-36545. By using those having moisture content of less than or equal to 8%, deterioration of visibility of exposed image or plate wear of photosensitive printing paper is prevented.

However, even with a packaging structure such as described above, film peeling could occur when interleaf sheets or pieces of protection cardboard and coating films of planographic printing plates are rubbed by each other.

Further, when planographic printing plates having interleaf sheets or pieces of protection cardboard contacting thereto in this manner are used in an automatic plate making machine or the like, the interleaf sheets or the pieces of protection cardboard need to be separated from the planographic printing plates. Therefore, efficiency of a plate making operation can be improved by using an automatic plate-making machine having an automatic plate feeding function which automatically separates interleaf sheets and feeds planographic printing plates, a so-called plate setter, or the like.

However, if interleaf sheets or pieces of protection cardboard are strongly adhering to planographic printing plates, the interleaf sheets or the pieces of protection cardboard are fed together with the planographic printing plates without being separated therefrom, and therefore inconveniences such as stop of an automatic plate feeding operation may be caused.

For example, when an interleaf sheet is sucked and lifted by suction cups or the like in a state in which the interleaf sheet contacts an imaging surface (a surface with a coating film) of a planographic printing plate, the interleaf sheet and the planographic printing plate may be lifted and fed together. When a planographic printing plate is lifted with a non-imaging surface (a surface without a coating film) thereof being sucked, the planographic printing plate may be fed with an interleaf sheet adhering to the imaging surface thereof. Further, when a planographic printing plate is lifted with an imaging surface or a non-imaging surface (which is not in contact with an interleaf sheet) thereof being sucked, the planographic printing plate may be fed with interleaf sheets and planographic printing plates adhering to the underside thereof.

### SUMMARY OF THE INVENTION

In view of the aforementioned, a task of the present invention is to obtain a planographic printing plate packaging material which has high separability from a non-imaging surface of a planographic printing plate and can be produced at low costs; and a planographic printing plate packaging structure using this packaging material.

In view of the aforementioned, another task of the present invention is to obtain a planographic printing plate packaging material and a planographic printing plate packaging structure which are low cost and can prevent film peeling with certainty. Yet another task of the present invention is to obtain a planographic printing plate packaging material which has high separability from an imaging surface of a planographic printing plate and can protect the imaging surface with certainty without affecting the quality of the imaging surface; and a planographic printing plate packaging structure using this packaging material.

A first aspect of the present invention is a material for packaging a planographic printing plate, wherein the printing plate includes an imaging surface having a coating film and is to be fed through an automatic plate-feeding mechanism, the material including opposing surfaces, one surface being for contacting the imaging surface of a printing plate when the material is used for packaging the printing plate, and the opposing surface having a Bekk smoothness from 3 seconds to 55 seconds.

A second aspect of the present invention is a material for packaging a planographic printing plate, wherein the printing plate includes a coating film, the material including a contact surface which contacts the coating film of a printing plate when the material is used for packaging the printing plate, the contact surface having a Bekk smoothness from 3 seconds to 900 seconds, and a noncontact surface opposing the contact surface.

By using the planographic printing plate packaging material whose contacting portion which contacts the coating film of the planographic printing plate has Bekk smoothness between 3 seconds and 900 seconds, as described above, film peeling is prevented with certainty, even when the contacting portion and the coating film are rubbed by each other, for example, during transportation.

Materials for the planographic printing plate packaging material are not particularly limited as long as the contacting portion satisfies either one of the Bekk smoothness conditions described above. Therefore, the planographic printing plate packaging material can be produced at low cost by selecting low cost materials.

In the second aspect of the present invention, preferably, Bekk smoothness of the contacting portion may be between 3 seconds and 100 seconds.

Therefore, film peeling is prevented with more certainty.

In the second aspect of the present invention, preferably, Bekk smoothness of the contacting portion may be between 250 seconds and 900 seconds.

Therefore, film peeling is prevented with more certainty.

In the second aspect of the present invention, preferably, Bekk smoothness of the contacting portion may be between 8 seconds and 560 seconds.

Setting the Bekk smoothness of the contacting portion between 8 seconds and 560 seconds provides the contacting portion with high separability from the coating portion of the planographic printing plate. Therefore, for example, when an automatic plate-making machine having an automatic plate feeding function which automatically separates the planographic printing plate packaging material and feeds the planographic printing plate, a so-called plate setter, or the like is used, the planographic printing plate packaging material and the planographic printing plate are prevented from being fed together in a state in which they adhere each other. Therefore, an automatic plate feeding operation is not stopped.

A planographic printing plate packaging structure of the present invention utilizing the planographic printing plate packaging material having the contacting portion which satisfies any one of the Bekk smoothness conditions described above to package the planographic printing plate is characterized in that the contacting portion contacts the coating film of the planographic printing plate to package the planographic printing plate.

Therefore, when the planographic printing plate is packaged by this planographic printing plate packaging structure for transportation or the like, film peeling is prevented with certainty even when the contacting portion and the coating film are rubbed by each other during the transportation or the like.

Further, by using the planographic printing plate packaging material formed by low cost materials, the planographic printing plate packaging structure can also be formed at low cost.

### BRIEF DESCRIPTION OF THE DRAWINGS

FIG. 1 is a perspective view showing a process to package planographic printing planes using planographic printing plate packaging materials of a first embodiment of the present invention.

FIG. 2 is a perspective view showing a state in which the planographic printing plates are packaged using the planographic printing plate packaging materials of the first embodiment of the present invention.

FIG. 3 is a perspective view showing a process to package the planographic printing plates using planographic printing plate packaging materials of a second embodiment of the present invention.

FIG. 4 is a perspective view showing a process to package the planographic printing plates using a planographic printing plate packaging material of a third embodiment of the present invention.

### DESCRIPTION OF THE PREFERRED EMBODIMENTS

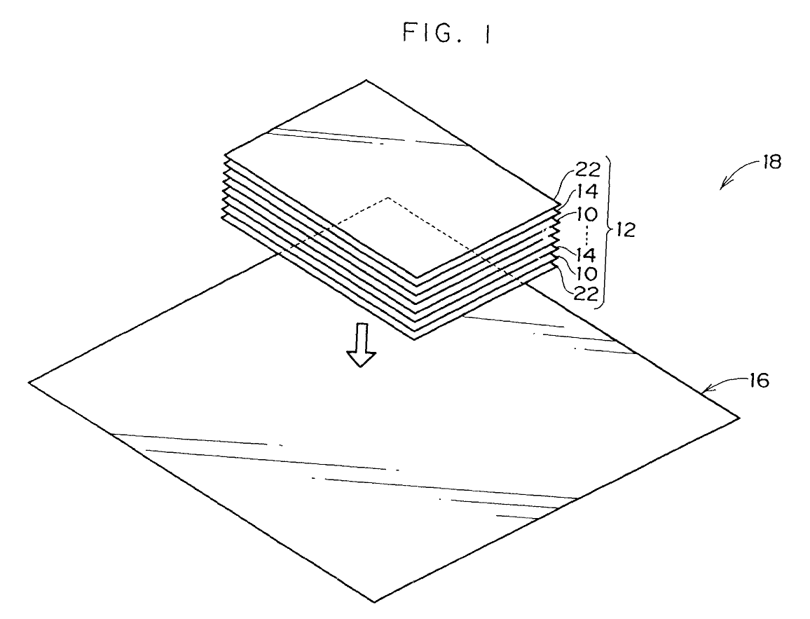

FIG. 1 shows a part of a process for packaging planographic printing plates 10 using interleaf sheets (planographic printing plate packaging material) 14 relating to a first embodiment of the present invention.

The planographic printing plate 10 is formed by coating a coating film (a photosensitive layer for a photosensitive printing plate, and a heat sensitive layer for a heat sensitive printing plate) onto a thin aluminum substrate in a form of a rectangular plate. This coating film is subjected to a plate making process including exposure, developing treatment, gum coating and the like, set into a printing machine, and applied with ink to print text, image or the like onto a paper surface. The planographic printing plates 10 of the present embodiment are ones at a step before being subjected to a processing necessary for printing (such as exposure, development and the like), and may be referred to planographic printing plate precursors or planographic printing plate materials in some cases.

A specific structure of the planographic printing plate 10 is not particularly limited as long as it has the above-described structure. However, for example, by making it a planographic printing plate for heat-mode type and photon type laser printing, it can be made a planographic printing plate which allows direct plate making from digital data.

Further, by selecting components in a photosensitive layer or a heat sensitive layer, various types of planographic printing plates 10 can be made corresponding to various plate making methods. Examples of specific aspects of the planographic printing plate of the present invention include aspects (1) to (11) below:

(1) An aspect wherein the photosensitive layer contains an infrared ray absorbent, a compound which generates an acid when heated, and a compound which is cross-linked by acids.

(2) An aspect wherein the photosensitive layer contains an infrared ray absorbent, and a compound which becomes soluble in alkaline when heated.

(3) An aspect wherein the photosensitive layer includes two layers: a layer containing a compound which generates radical when exposed by a laser beam, a binder which is soluble in alkaline, and a polyfunctional monomer or prepolymer; and an oxygen-blocking layer.

(4) An aspect wherein the photosensitive layer is formed of two layers: a physical development center layer and a silver halide emulsion layer.

(5) An aspect wherein the photosensitive layer includes three layers: a polymer layer containing a polyfunctional monomer and a polyfunctional binder, a layer containing silver halide and a deoxidizer, and an oxygen-blocking layer.

(6) An aspect wherein the photosensitive layer includes two layers: a layer containing novolak resin and naphthoquinonediazide, and a layer containing silver halide.

(7) An aspect wherein the photosensitive layer contains an organic photoconductive material.

(8) An aspect wherein the photosensitive layer includes two to three layers including a laser beam absorbing layer which is removed by laser beam exposure and a lipophilic layer and/or hydrophilic layer.

(9) An aspect wherein the photosensitive layer contains a compound which absorbs energy and generates oxygen; a high molecular compound having in its side chain a functional group which generates sulfonic acid or carboxylic acid by acids; and a compound which absorbs visible light to provide energy to an acid generator.

(10) An aspect wherein the photosensitive layer contains a quinonediazide compound and novolak resin.

(11) An aspect wherein the photosensitive layer contains a compound which decompose by light or ultraviolet ray and forms a self-bridging structure or a bridging structure with other molecules in the layer; and a binder which is soluble in alkaline.

Particularly, in recent years, a planographic printing plate coated with a coating film of high-sensitivity photosensitive type for laser exposure, or a heat sensitive type planographic printing plate may be used (for example, the above-described aspects (1) to (3)). However, in a case of such a high sensitivity type planographic printing plate, deterioration of the imaging surface can be prevented with certainty by using the planographic printing plate packaging material of the present invention.

The planographic printing plates 10 of the present embodiment (planographic printing plates of all the aspects (1) to (11) described above) are planographic printing plates which may be set in an automatic plate-making machine having an automatic plate feeding function or in a so-called plate setter in a state in which a stack 12 is formed, and be fed to a plate making process (plate feeding). As described later, in a structure which prevents the planographic printing plates 10 and the planographic printing plate packaging materials from being fed together into an automatic plate-making machine or the like by using the planographic printing plate packaging material having a Bekk smoothness between 8 seconds and 560 seconds, deterioration of the imaging surface can be prevented with certainty by using the planographic printing plate packaging materials of the present invention, without depending on how the planographic printing plates are handled, that is, if they are fed by a user using an automatic plate feeding mechanism, or they are fed manually by the user, or the like (in other words, as an issue prior to feeding methods). Of course, all planographic printing plates which may possibly be set in an automatic plate-making machine having an automatic plate feeding function or in a so-called plate setter and fed to a plate-making process (plate feeding), are included in the planographic printing plates 10 of the present embodiment, even if the aspect of the planographic printing plate is not one of the aspects (1) to (11).

When being set in an automatic plate-making machine having an automatic plate feeding function or in a so-called plate setter, the planographic printing plates 10 and the interleaf sheets 14 may be set in a small amount such as two each without pieces of protection cardboard 22 described later.

As can be seen from FIG. 1, the stack 12 of the planographic printing plates 10 is formed of the interleaf sheets 14 for protecting the coating film and the planographic printing plates 10 being alternately stacked in a thickness direction and the pieces of protection cardboard 22 being positioned on the top and bottom surfaces thereof. The number of the planographic printing plates 10 forming a single stack 12 is not particularly limited, however, may be, for example, 10 to 100 pieces in terms of efficiency in transportation or storage, or the like. When the stack 12 is formed of 10 to 100 pieces of planographic printing plates 10, it is preferable to secure them by securing means such as an adhesive tape so that the planographic printing plates 10 and the pieces of protection cardboard 22 are not offset. Further, it is possible to form the stack 12 with more planographic printing plates 10 in order to enable more efficient transportation or storage (with less handling frequency). For example, the maximum number of the planographic printing plates 10 may be set around 300 pieces, and a piece of the protection cardboard 22 may be placed at every 20 to 100 pieces of the planographic printing plates 10. Furthermore, the maximum number of the planographic printing plates 10 may be set around 3000 pieces, and pieces of the protection cardboard 22 may be placed only at the top and the bottom thereof. In addition, the protection cardboard 22 may not be used depending on types of the planographic printing plates 10.

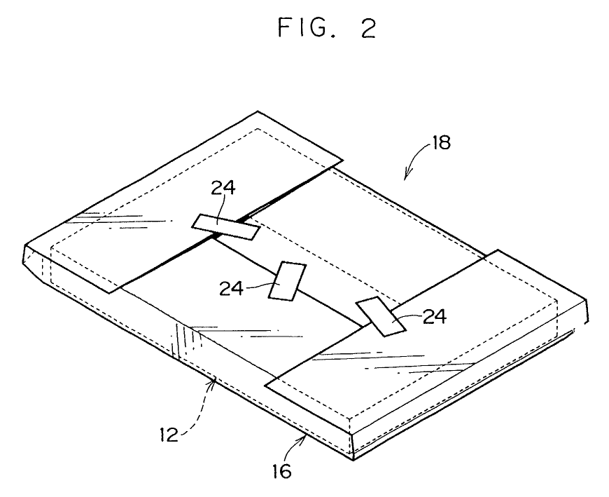

The stack 12 thus formed is packaged by a piece of inner packaging paper 16, and the piece of inner packaging paper 16 is taped at predetermined positions with pieces of adhesive tape 24 as shown in FIG. 2. The inner packaging paper is thereby fixed so as not to loosen or fall off, and the planographic printing plates 10 are shielded from light and moisture with certainty. In the first embodiment, a planographic printing plate packaging structure 18 of the present embodiment is formed by packaging this stack 12 with the piece of inner packaging paper 16. The stack 12 may be further packaged by an outer packaging box or may be loaded on a pallet depending on types of the planographic printing plates 10 or how they are carried.

First, the interleaf sheet 14 of the present embodiment is made to have Bekk smoothness of a non-contacting surface thereof between 3 seconds and 55 seconds.

Table 1 shows relationship between Bekk smoothness of a non-contacting surface of a planographic printing plate packaging material and separability thereof from a non-imaging surface of a planographic printing plate 10. The term “separability” herein means how easily the interleaf sheet 14 separates from the non-imaging surface when the stack 12 is set in an automatic plate-making machine having an automatic plate-feeding function, a so-called plate-setter, or the like, to feed the planographic printing plate 10 to the automatic plate-making machine. “◯” means that the interleaf sheet 14 is separated from the non-imaging surface without any problem, and “×” means that the interleaf sheet 14, sometimes, adheres to and is not separated from the non-imaging surface, and fed together with the planographic printing plate 10.

The “Example of Application” in Table 1 is merely an example. Therefore, a packaging material with a contacting portion having Bekk smoothness between 3 seconds and 11 seconds may be used as the interleaf sheet 14 and a packaging material having Bekk smoothness between 15 and 55 seconds may be used as a protection cardboard 32 as described later.

TABLE 1

| | | | | | | |
|---|---|---|---|---|---|---|
| Bekk Smoothness | 3 | 11 | 15 | 28 | 55 | 65 |
| (sec.) | | | | | | |
| Separability | ◯ | ◯ | ◯ | ◯ | ◯ | X |

| | | |
|---|---|---|
| Example of | Protection | Interleaf Sheet |
| Application | Cardboard | |

It can be seen from this Table 1 that the packaging materials having Bekk smoothness between 3 seconds and 55 seconds are separated from the non-imaging surface with certainty when the stack 12 is set in an automatic plate-making machine having an automatic plate feeding function, a so-called plate setter, or the like, to feed the planographic printing plates 10 to the automatic plate making machine. Since the interleaf sheet 14 of the present embodiment is made to have Bekk smoothness between 3 seconds and 55 seconds, there is no such a case in that the interleaf sheet 14 adheres to the non-imaging surface of the planographic printing plates 10 and the interleaf sheet 14 is fed together with the planographic printing plates 10 to an automatic plate-making machine or the like, to stop a feeding operation.

Thus, by making the interleaf sheet 14 to have Bekk smoothness between 3 seconds and 55 seconds in the present embodiment, the interleaf sheet 14 can be separated from the non-imaging surface with certainty in an automatic plate-feeding mechanism and deterioration of the imaging surface is prevented.

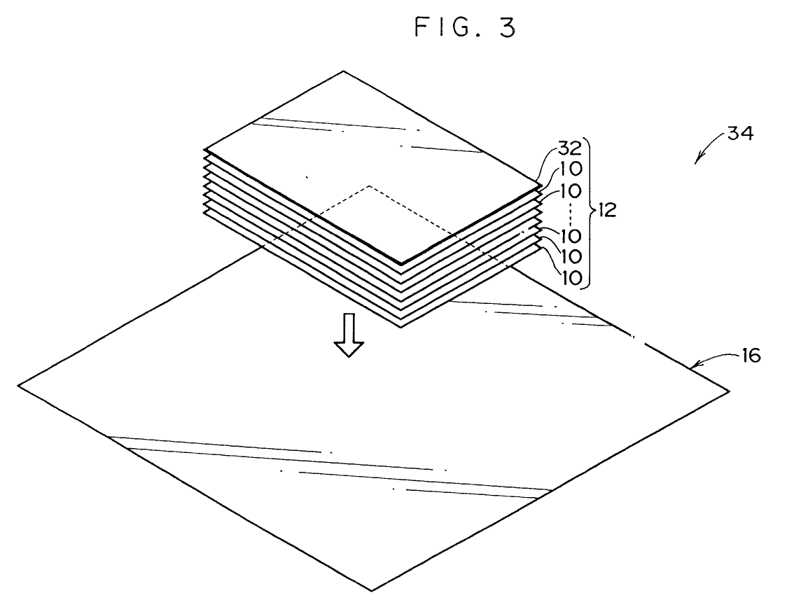

FIG. 3 shows a process of packaging the planographic printing plates 10 using the protection cardboard (planographic printing plate packaging material) 32 relating to a second embodiment of the present invention.

Further, in the second embodiment, a non-contacting surface (a surface which contacts a non-imaging surface, which is undersurface as shown in FIG. 3) of the protection cardboard 32 is made to have Bekk smoothness between 3 seconds and 55 seconds, as in the first embodiment. Therefore, in the second embodiment, the protection cardboard 32 is separated from the non-imaging surface with certainty in an automatic plate-feeding mechanism.

As explained above, in either of the embodiments of the present invention, the non-contacting surfaces (non-contacting portions) of the planographic printing plate packaging materials (the interleaf sheet 14 and the protection cardboard 32) are made to have Bekk smoothness between 3 seconds and 55 seconds, and therefore, the planographic printing plate packaging materials are separated from the non-imaging surfaces of the planographic printing plates 10 with certainty in an automatic plate-feeding mechanism and deterioration of the imaging surfaces is prevented. In addition, as long as Bekk smoothness of the non-contacting surface is set as described above, materials and other physical properties of the planographic printing plate packaging material are not particularly limited. Therefore, wider range of materials can be selected, so that, for example, low cost materials can be used for producing the planographic printing plate packaging material.

The planographic printing plate packaging material of the present invention is not limited to the interleaf sheets 14 and the protection cardboard 32 described above. That is, ones, which contact and protect the imaging surface of the planographic printing plate 10 according to packaging forms, and whose non-contacting portions which contact the non-imaging surface satisfy the above described Bekk smoothness value requirement, are included in the planographic printing plate packaging material of the present invention.

Second, a contacting portion, which contacts the coating film of the planographic printing plate 10, of the interleaf sheet 14 of the present embodiment is made to have Bekk smoothness between 3 seconds and 900 seconds.

Table 2 shows relationship between Bekk smoothness of the contacting portion (a portion contacting the coating film) of the planographic printing plate packaging material of the present invention and film peeling. In evaluations of the film peeling tendencies of this table, “⊚” means that there is no film peeling, and “◯” means that there may be slight film peeling depending on types of the planographic printing plates 10 but degree of the peeling is not so serious to cause practical problems. The “Example of Application” in Table 2 is merely an example. Therefore, a packaging material with a contacting portion having Bekk smoothness between 3 seconds and 13 seconds may be used as the interleaf sheet 14 and a packaging material having Bekk smoothness between 60 and 900 may be used as a protection cardboard 32 as described later.

TABLE 2

| | | | | | | | | | | | | | | | | |
|---|---|---|---|---|---|---|---|---|---|---|---|---|---|---|---|---|
| Beck Smoothness (sec.) | 3 | 7 | 8 | 10 | 13 | 60 | 65 | 100 | 140 | 190 | 250 | 420 | 560 | 600 | 755 | 900 |
| Film Peeling Tendency | ⊚ | ⊚ | ⊚ | ⊚ | ⊚ | ⊚ | ⊚ | ⊚ | ◯ | ◯ | ⊚ | ⊚ | ⊚ | ⊚ | ⊚ | ⊚ |
| Separability from Coating Film | ◯ | ◯ | ⊚ | ⊚ | ⊚ | ⊚ | ⊚ | ◯ | ⊚ | ⊚ | ⊚ | ⊚ | ⊚ | ◯ | ◯ | ◯ |

| | | |
|---|---|---|
| Example of Application | Protection Cardboard | Interleaf Sheet |

It can be seen from this Table 2 that film peeling substantially is not caused by the packaging materials with the contacting portions having Bekk smoothness between 3 seconds and 900 seconds. Since the packaging materials having Bekk smoothness between 3 seconds and 900 seconds are used in the present embodiment as the interleaf sheets 14, no film peeling of the planographic printing plates 10 is caused. Particularly, use of packaging materials with contacting portions having Bekk smoothness between 3 seconds and 100 seconds or between 250 seconds and 900 seconds is preferable since no film peeling is caused regardless of types of the planographic printing plates 10. For example, even when the interleaf sheets 14 and the coating films are rubbed by each other during transportation or the like, so-called film peeling is prevented with certainty.

In addition, the planographic printing plates 10 of the present embodiment may be made as such planographic printing plates which are set in an automatic plate-making machine having an automatic plate feeding function, in a so-called plate setter, or the like in a state in which they are forming the stack 12 as described above, and fed into a plate-making process (plate feeding).

Table 2 also shows relationship between Bekk smoothness of the contacting portions of the planographic printing plate packaging materials of the present invention and separability from the coating films. “Separability from Coating Film” in Table 2 means how easily the packaging material can be separated from the coating film in a case in which the stack 12 is set in an automatic plate-making machine having an automatic plate feeding function, in a so-called plate setter, or the like, and fed into the automatic plate-making machine. “⊚” indicates that the packaging material is separated from the coating film without any problem, and “◯” indicates that the packaging material sometimes may not be separated from the coating film of the planographic printing plates 10 of very limited types, and the planographic printing plates 10 and the packaging materials may be fed together.

From this Table 2, it can be seen that, using the packaging materials with the contacting portions having Bekk smoothness between 8 seconds and 560 seconds, the packaging materials are separated from the coating films with certainty regardless of types of the planographic printing plates 10 when the stack 12 is set in an automatic plate-making machine having an automatic plate feeding function, in a so-called plate setter, or the like, and fed into the automatic plate making machine. In addition, although Bekk smoothness is out of this range, as long as it satisfies a condition of being between 3 seconds and 900 seconds, the packaging materials are separated from the coating films with certainty by appropriately selecting the types of the planographic printing plates 10. Therefore, the packaging materials are not fed into an automatic plate making machine, or the like, together with the planographic printing plates 10, and a plate feeding operation is not stopped.

As described above, since the present embodiment uses the interleaf sheets 14 with the contacting portions having Bekk smoothness between 3 seconds and 900 seconds, when appropriate planographic printing plates 10 are selected and used, the interleaf sheets 14 are not fed into an automatic plate making machine, or the like, together with the planographic printing plates 10. Particularly, when the interleaf sheets 14 with the contacting portions having Bekk smoothness between 8 seconds and 560 seconds are used, the interleaf sheets 14 are prevented from being fed into an automatic plate making machine or the like together with the planographic printing plates 10 with certainty regardless of types of the planographic printing plates 10.

In addition, as long as the interleaf sheets 14 satisfy the condition of Bekk smoothness in this manner, materials and other physical properties thereof are not particularly limited. Therefore, the interleaf sheets 14 can be produced at low cost by selecting low cost materials. For example, 100% wood pulp paper, paper which is not totally made of wood pulp but made of synthetic pulp, paper of these types provided with a low density polyethylene layer, and the like can be used as the interleaf sheets 14. Particularly, since material costs for paper without synthetic pulp is low, the interleaf sheets 14 can be produced at low cost by using the paper without synthetic pulp. More specifically, interleaf sheets produced from bleached Kraft pulp, having basic weight of 30 to 60 g/m², density of 0.7 to 0.85 g/cm³, moisture of 4 to 6%, and pH of 4 to 6 are included, however, of course, this is not to limit such interleaf sheets.

FIG. 3 shows a process of packaging planographic printing plates 10 using a piece of protection cardboard (planographic printing plate packaging material) 32 relating to a second embodiment of the present invention.

In the second embodiment, the interleaf sheets 14 are not used, and only planographic printing plates 10 are stacked so that coating films thereof are oriented in the same direction (upward in FIG. 3). The piece of protection cardboard 32 is placed to contact the coating film of the topmost planographic printing plate 10. A stack 12 is formed by the stacked planographic printing plates 10 and the piece of protection cardboard 32. In the second embodiment, a planographic printing plate packaging structure 34 of the present embodiment is formed by packaging the stack 12 with a piece of inner packaging paper 16, as in the first embodiment.

Further, in the second embodiment, Bekk smoothness of the contacting portion (a portion contacting the coating film) of the piece of protection cardboard 32 is between 3 seconds and 90 seconds as the contacting portions of the interleaf sheets 14 of the first embodiment. Therefore, in the second embodiment, film peeling is also prevented in such a case in which the piece of protection cardboard 32 and the coating film are rubbed by each other, for example, during transportation or the like. Particularly, when a piece of the protection cardboard 32 with a contacting portion having Bekk smoothness between 3 seconds and 100 seconds or between 250 seconds and 900 seconds is used, film peeling of the planographic printing plates 10 is prevented regardless of types of the planographic printing plates 10.

In addition, as long as the protection cardboard 32 satisfies either one of the Bekk smoothness conditions described above, materials and other physical properties thereof are not particularly limited. For example, wood pulp, natural fiber such as hemp, synthetic pulp obtained from linear macromolecule such as plyolefine or the like, regenerated cellulose, or the like, can be used solely or in combination as materials for the protection cardboard 32. Particularly, the protection cardboard 32 can be produced at low cost by selecting low cost materials such as wood pulp or natural fiber. More specifically, the protection cardboard 32 having density of 0.72 g/cm³ and basic weight of 640 g/m², which is produced by using stuff obtained by beating material waste paper, adding a sizing agent of 0.1% of a cardboard weight and a strengthener of 0.2% of the cardboard weight to the stuff diluted to a density of 4%, and further adding aluminum sulfate to the stuff until pH becomes 5.0, can be included, however, of course, this is not to limit the protection cardboard 32 of the present invention.

Also in the second embodiment, when the planographic printing plates 10 are fed by an automatic plate feeding mechanism, the interleaf sheets 14 are prevented from being fed into an automatic plate making machine or the like together with the planographic printing plates 10 with certainty regardless of the types of the planographic printing plates 10 by using the one having Bekk smoothness between 8 seconds and 560 seconds. In addition, even when a Bekk smoothness of the contacting portion is out of this range, the interleaf sheets 14 are prevented from being fed into an automatic plate making machine, or the like, together with the planographic printing plates 10 by selecting planographic printing plates which are appropriate as the planographic printing plates 10.

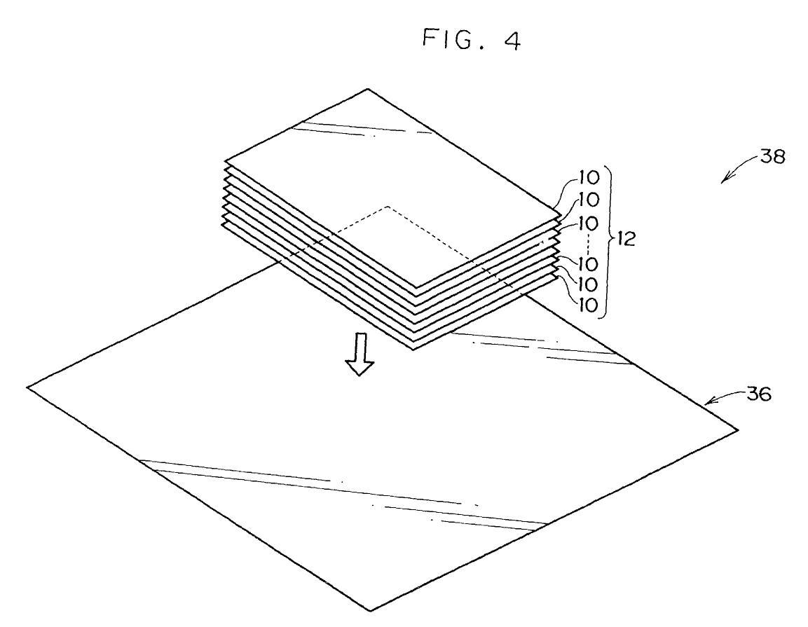

FIG. 4 shows a process of packaging planographic printing plates 10 using a piece of inner packaging paper (planographic printing plate packaging material) 36 relating to a third embodiment of the present invention.

In the third embodiment, a stack 12 is formed only by planographic printing plates 10 without using the interleaf sheets 14 and the pieces of protection cardboard 22 of the first embodiment, and the piece of protection cardboard 32 of the second embodiment. A planographic printing plate packaging structure of the present embodiment is formed by packaging the stack 12 with a piece of inner packaging paper 36. Therefore, a portion of the piece of inner packaging paper 36 is a contacting portion which contacts a coating film of the planographic printing plate 10.

The contacting portion of the piece of inner packaging paper 36 is made to have Bekk smoothness between 3 seconds and 900 seconds. Therefore, film peeling in a case in which the piece of inner packaging film 36 and the coating film are rubbed by each other, for example, during transportation or the like is prevented also in the third embodiment.

In addition, as long as the inner packaging paper 36 satisfies the Bekk smoothness condition described above, materials and other physical properties thereof are not particularly limited. Therefore, the inner packaging paper 36 can be produced at low cost by selecting low cost materials.

As explained above, in either of the embodiments of the present invention, the contacting portions of the planographic printing plate packaging materials (the interleaf sheets 14, the piece of protection cardboard 32, and the piece of packaging paper 36) are made to have Bekk smoothness between 3 seconds and 900 seconds, so that film peeling can be prevented with certainty. In addition, by further limiting Bekk smoothness of the contacting portions in a range between 8 seconds and 560 seconds in the first embodiment and the second embodiment, the interleaf sheets 14 are prevented from being fed together with the planographic printing plates 10 with certainty regardless of types of the planographic printing plates 10 when the planographic printing plates 10 are fed by using an automatic plate feeding mechanism. Further, since materials and physical properties of the planographic printing plate packaging material are not particularly limited except that Bekk smoothness of the contacting portion is set as described above, wider range of materials can be selected, so that, for example, low cost materials can be used for producing the planographic printing plate packaging material.

The planographic printing plate packaging material of the present invention is not limited to the interleaf sheets 14, the piece of protection cardboard 32 and the piece of inner packaging paper 36 described above. That is, one, whose contacting portion which contacts the coating film of the planographic printing plate 10 according to the packaging forms of the planographic printing plates 10 satisfies the above described Bekk smoothness value requirement, is included in the planographic printing plate packaging material of the present invention. For example, when the planographic printing plates 10 are packaged in an outer packaging material made of paper (such as corrugated fiberboard (cardboard), Kraft paper and honeycomb construction material made of paper) or other material without using interleaf sheets, pieces of protection cardboard or a piece of inner packaging paper, the outer packaging material is included in the planographic printing plate packaging material of the present invention as long as a contacting portion of the outer packaging material satisfies the above described Bekk smoothness value.

When the planographic printing plates 10 are directly loaded on a loading member such as a pallet or a skid, as long as at least contacting portions of the loading member (and contacting portions of, if any, other members for fixing or the like) satisfy the above described Bekk smoothness value, the outer packaging material, the fixing members or the like are included in the planographic printing plate packaging material of the present invention.

What is claimed is:

1. A material for packaging a planographic printing plate, wherein the printing plate includes an imaging surface having a coating film and is to be fed through an automatic plate-feeding mechanism, the material comprising opposing surfaces, one surface being for contacting the imaging surface of a printing plate when the material is used for packaging the printing plate, and the opposing surface having a Bekk smoothness from 3 seconds to 55 seconds.

2. A package structure comprising:
at least one planographic printing plate having an imaging surface for feeding through an automatic plate feeding mechanism; and
a packaging material packaging the printing plate, the packaging material having opposing surfaces, with one surface contacting the imaging surface of the printing plate, and the opposing surface having a Bekk smoothness from 3 seconds to 55 seconds.

3. The material of claim 1, wherein the material comprises an interleaf sheet having a weight from 30 to 45 grams per square meter of the material, a density of 0.7 to 0.85 grams per cubic centimeter, a moisture of 4% to 6%, and a pH from 4 to 6.

4. The material of claim 1, wherein the material comprises cardboard having a weight of approximately 640 grams per square meter of the material and a density of approximately 0.72 gram per cubic centimeter.

5. The package of claim 2, wherein the packaging material comprises an interleaf sheet having a weight from 30 to 45 grams per square meter of the material, a density of 0.7 to 0.85 grams per cubic centimeter, a moisture of 4% to 6%, and a pH from 4 to 6.

6. The package of claim 2, wherein the packaging material comprises cardboard having a weight of 640 grams per square meter of the material and a density of 0.72 gram per cubic centimeter.

7. A material for packaging a planographic printing plate, wherein the printing plate includes a coating film, the material comprising a contact surface which contacts the coating film of a printing plate when the material is used for packaging the printing plate, the contact surface having a Bekk smoothness from 3 seconds to 900 seconds, and a noncontact surface opposing the contact surface.

8. The material of claim 7, wherein the contact surface has a Bekk smoothness from 3 seconds to 100 seconds.

9. The material of claim 7, wherein the contact surface has a Bekk smoothness from 250 seconds to 900 seconds.

10. The material of claim 7, wherein the contact surface has a Bekk smoothness from 8 seconds to 560 seconds.

11. The material of claim 10, wherein the material comprises an interleaf sheet having a weight from 30 to 45 grams per square meter of the material, a density of 0.7 to 0.85 grams per cubic centimeter, a moisture of 4% to 6%, and a pH from 4 to 6.

12. The material of claim 10, wherein the material comprises cardboard having a weight of 640 grams per square meter of the material and a density of 0.72 gram per cubic centimeter.

13. A package structure comprising:
at least one planographic printing plate having a coating film; and
a packaging material packaging the printing plate, the packaging material having a contact surface which contacts the coating film of the printing plate when the material is used for packaging the printing plate, the contact surface having a Bekk smoothness from 3 to 900.

14. The package structure of claim 13, wherein the contact surface has a Bekk smoothness from 3 to 100 seconds.

15. The package structure of claim 13, wherein the contact surface has a Bekk smoothness from 250 to 900 seconds.

16. The package structure of claim 13, wherein the contact surface has a Bekk smoothness from 8 to 560 seconds.

17. The package of claim 16, wherein the packaging material comprises an interleaf sheet having a weight from 30 to 45 grams per square meter of the material, a density of 0.7 to 0.85 grams per cubic centimeter, a moisture of 4% to 6%, and a pH from 4 to 6.

18. The package of claim 16, wherein the packaging material comprises cardboard having a weight of 640 grams per square meter of the material and a density of 0.72 gram per cubic centimeter.
